(19) United States
(12) Patent Application Publication
(10) Pub. No.: US 2022/0134361 A1
(43) Pub. Date: May 5, 2022

(54) SPRAY GUN WITH ADJUSTMENT ELEMENT

(71) Applicant: PROMEGA S.R.L., Botticino (Brescia) (IT)

(72) Inventors: Gualtiero GATELLI, Botticino (Brescia) (IT); Stefania GATELLI, Botticino (Brescia) (IT); Luca GATELLI, Botticino (Brescia) (IT)

(21) Appl. No.: 17/428,321

(22) PCT Filed: Feb. 7, 2020
(86) PCT No.: PCT/IB2020/050974

§ 371 Date: Aug. 4, 2021

(30) Foreign Application Priority Data
Feb. 15, 2019 (IT) 102019000002237

(51) Int. Cl. B05B 1/18; B05B 1/12; B05B 1/28; B05B 1/30; B05B 12/00; B05B 15/656

(52) U.S. Cl. CPC B05B 1/18; B05B 1/12; B05B 15/656; B05B 1/3026; B05B 12/0024; B05B 1/28

(57) ABSTRACT

A spray gun having a gun body is provided. A duct extends in the gun body between an inlet mouth and a main outlet mouth. The gun body has a handle, the inlet mouth located in the handle, extending along a handle axis; a barrel, the main outlet mouth formed in the barrel, extending along a barrel axis; and an adjustment element extending onto the barrel around and parallel to the barrel axis. The adjustment element has a central cavity accommodating the barrel and a secondary outlet mouth. The adjustment element is axially movable between a retracted position and a forward position, in which the adjustment element is advanced axially cantilevered on the barrel, with the secondary outlet mouth axially distal to the main outlet mouth, defining, within the central cavity, an adjustment chamber filled with water exiting the main outlet mouth to flow through the secondary outlet mouth.

The present invention relates to a spray gun for irrigating plants, flowers and/or vegetables. In particular, the spray gun is of the type which connectable to a flexible tube which supplies water, for example connected to a source included in a domestic and/or industrial network.

In the prior art many embodiments of spray guns which are mountable and fluidically connectible to a flexible tube are known.

The known spray guns are suitable for being operated by a user who can decide whether to spray the jet of water or inhibit the spray thereof.

Typically, the spray guns are suitable for being adjustable, varying the delivery flow rate as well as the mode and shape of the spray.

In particular, the known spray guns are adjustable in one or more configurations each with a different jet, in terms of shape and/or pressure and/or flow rate.

In the prior art, it has been verified that there are no spray gun solutions suitable for delivering a jet of water at low pressure and which is at the same time localized, homogeneous and laminar.

The object of the present invention is therefore to provide a spray gun which solves the aforementioned problem typical of the solutions of the prior art. Specifically, the object of the present invention is to provide a spray gun which is suitable, at least in one configuration, for producing a localized, homogeneous and laminar low pressure jet.

At the same time, the object of the present invention is to provide a spray gun which fulfils said object while remaining compact in size, simple to operate and above all not complex and cost-effective to manufacture.

According to the present invention, this object is achieved by the spray gun according to claim 1. Preferred embodiments of the invention are defined in the dependent claims.

The features and the advantages of the spray guns mentioned above will appear more clearly from the following description, made by way of an indicative and non-limiting example with reference to the accompanying figures, in which:

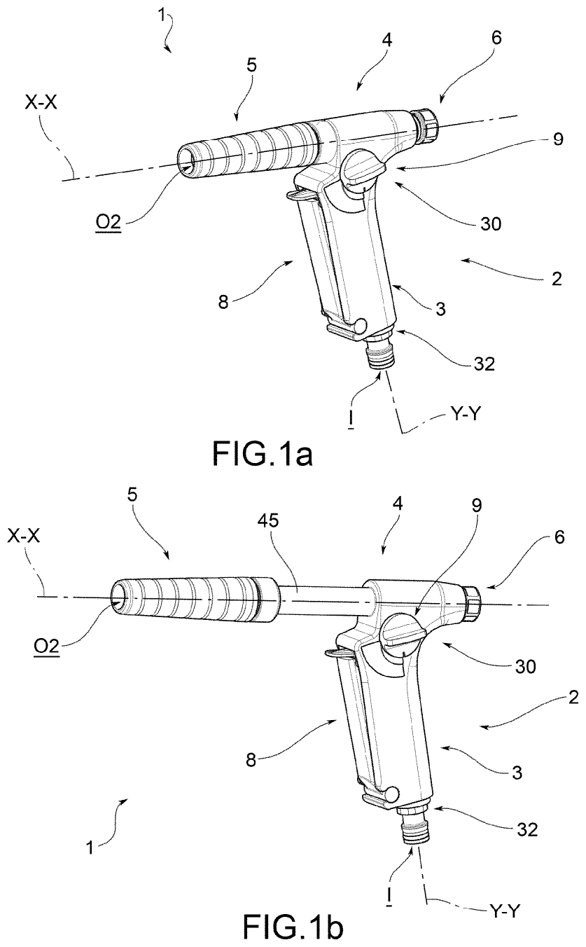

FIGS. 1a and 1b show two perspective views of a spray gun according to a preferred embodiment in which the adjustment element is in a retracted position and in a forward position, respectively;

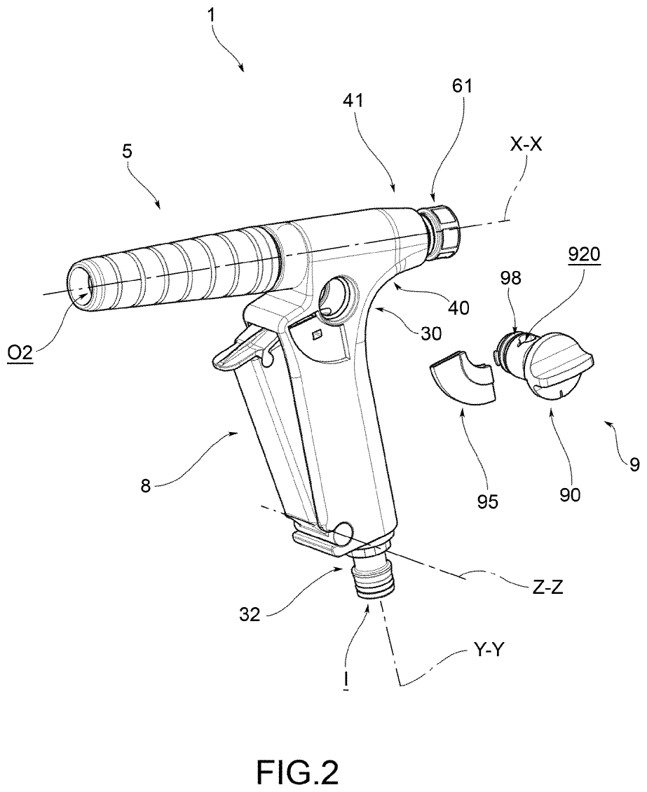

FIG. 2 shows a perspective view with separate parts of the spray gun of FIGS. 1a and 1b;

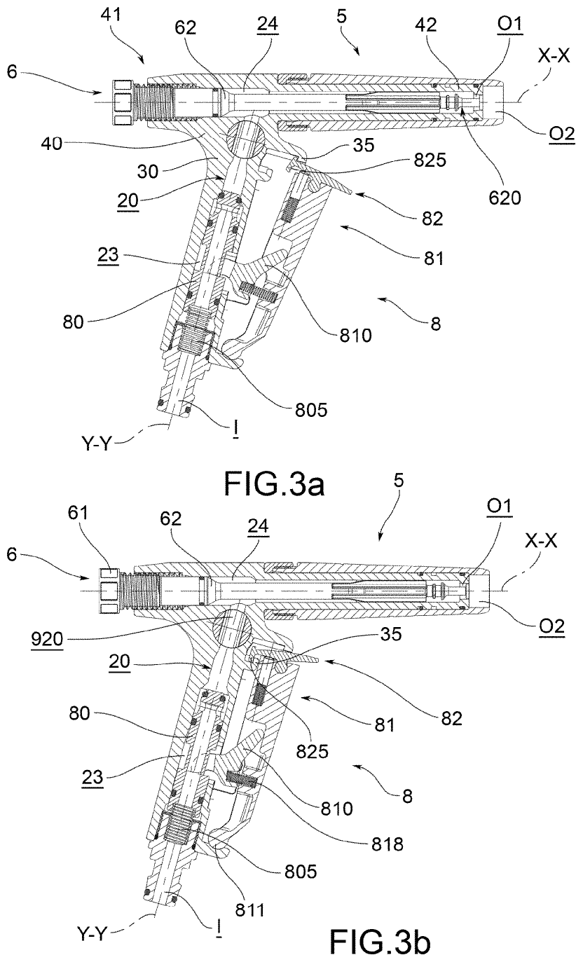

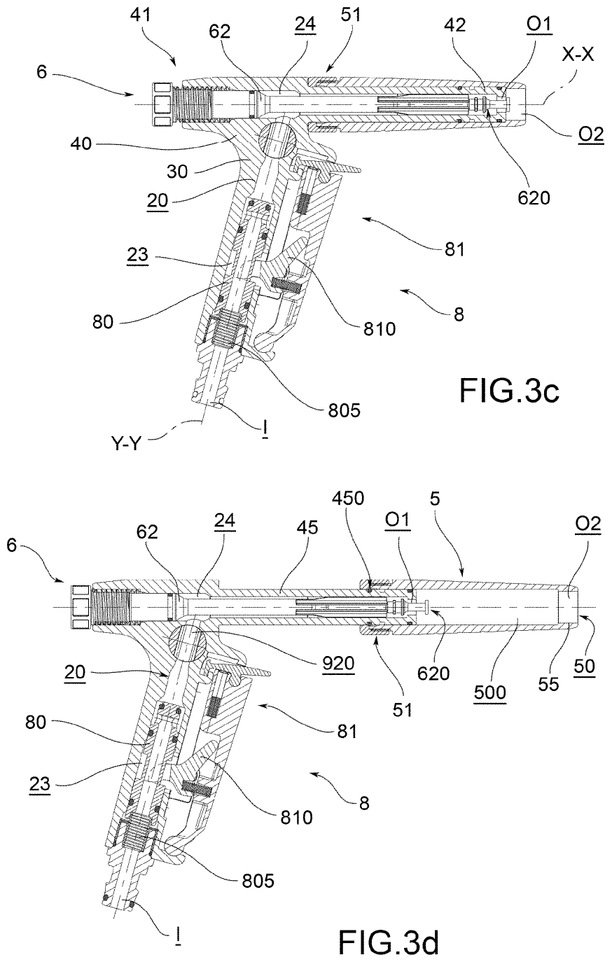

FIGS. 3a, 3b, 3c and 3d show some sectional views of the spray gun of FIGS. 1a and 1b, each corresponding to a respective operating configuration;

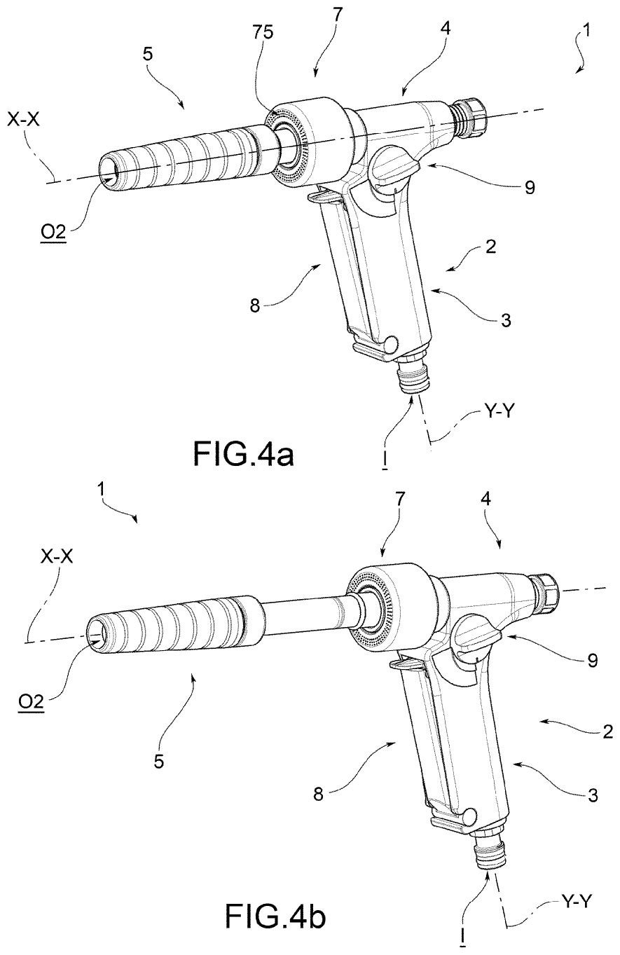

FIGS. 4a and 4b show two perspective views of a spray gun according to a preferred embodiment in which the adjustment element is in a retracted position and in a forward position, respectively;

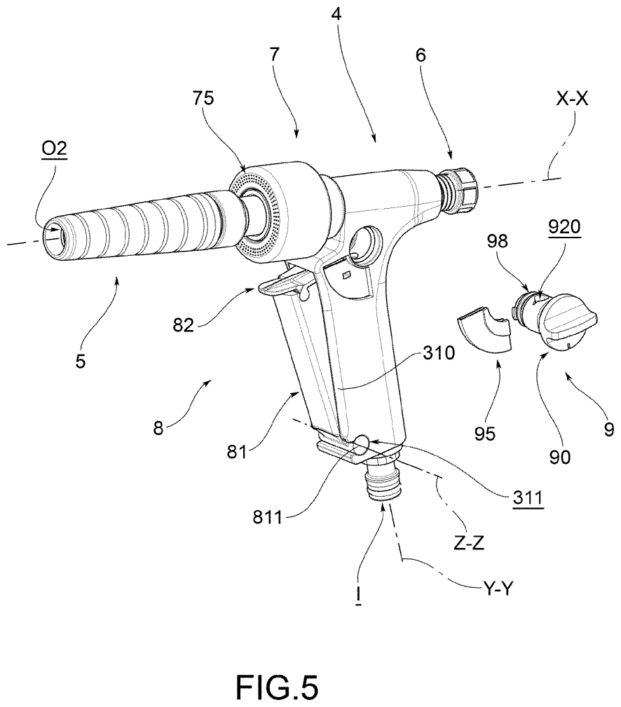

FIG. 5 shows a perspective view with separate parts of the spray gun of FIGS. 4a and 4b;

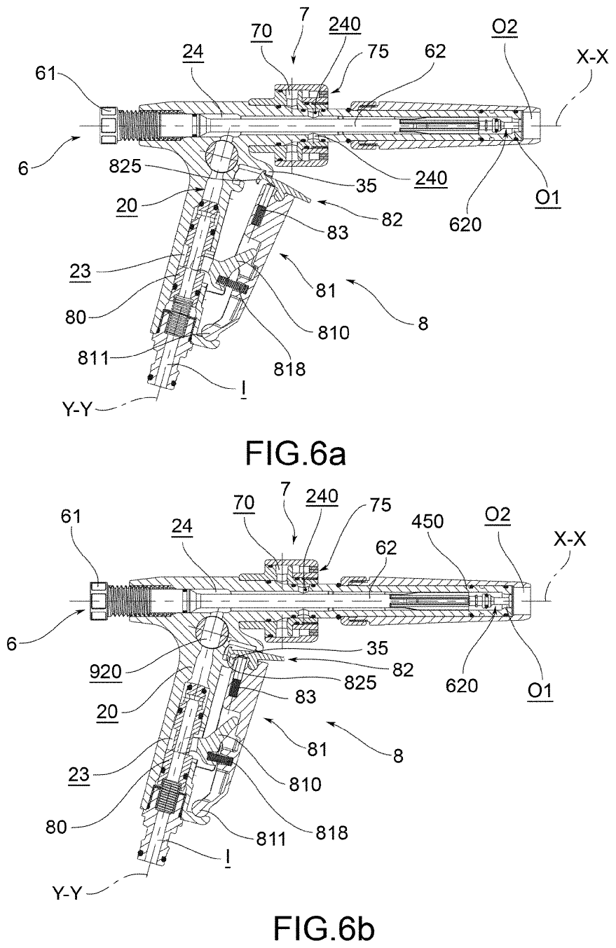

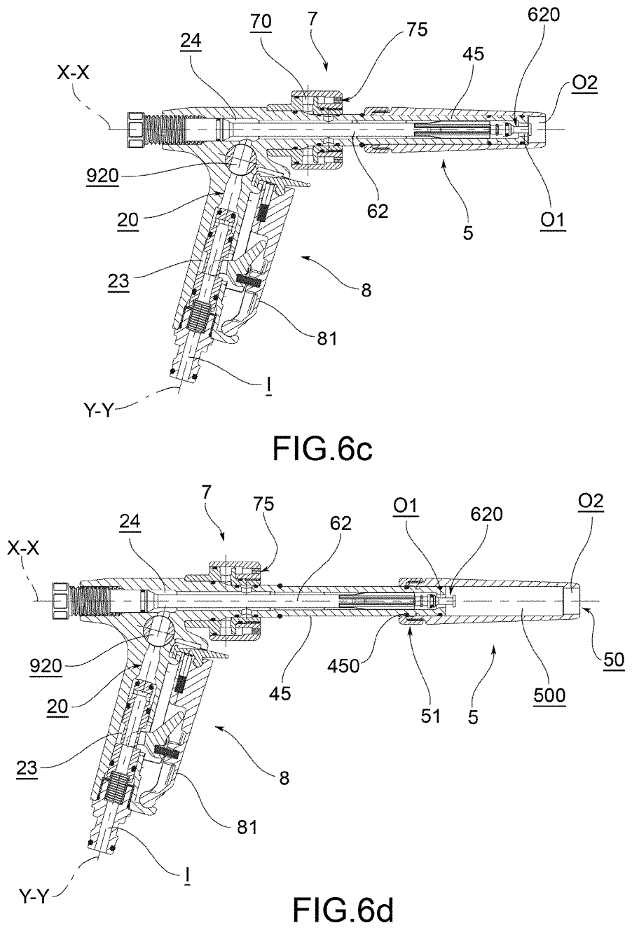

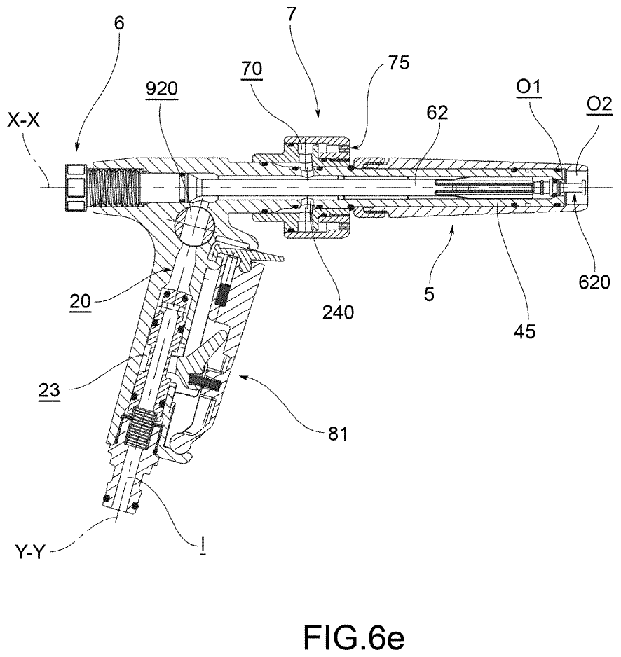

FIGS. 6a, 6b, 6c, 6d and 6e show some sectional views of the spray gun of FIGS. 4a and 4b, each corresponding to a respective operating configuration;

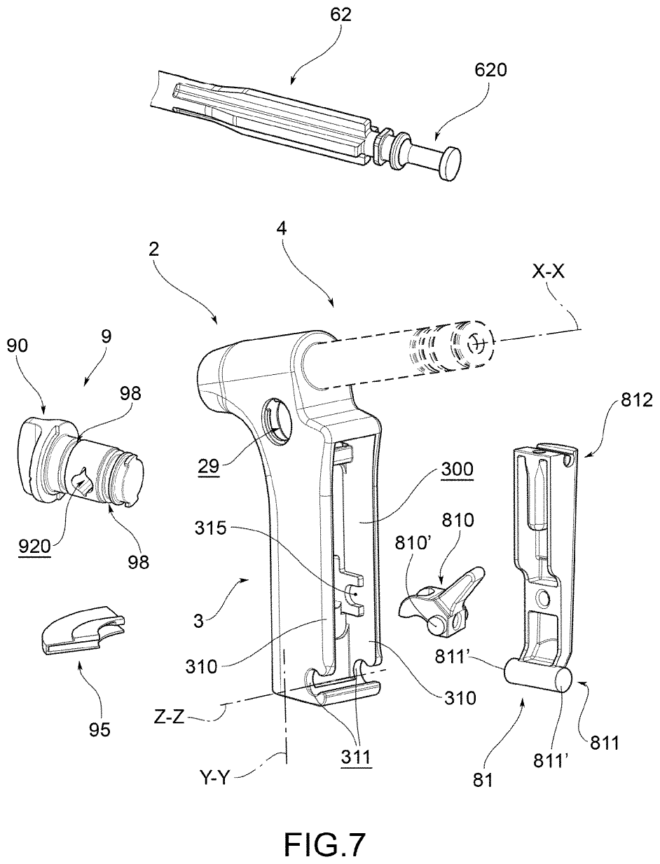

FIG. 7 shows some full or partial perspective views of some components of the spray gun object of the present invention;

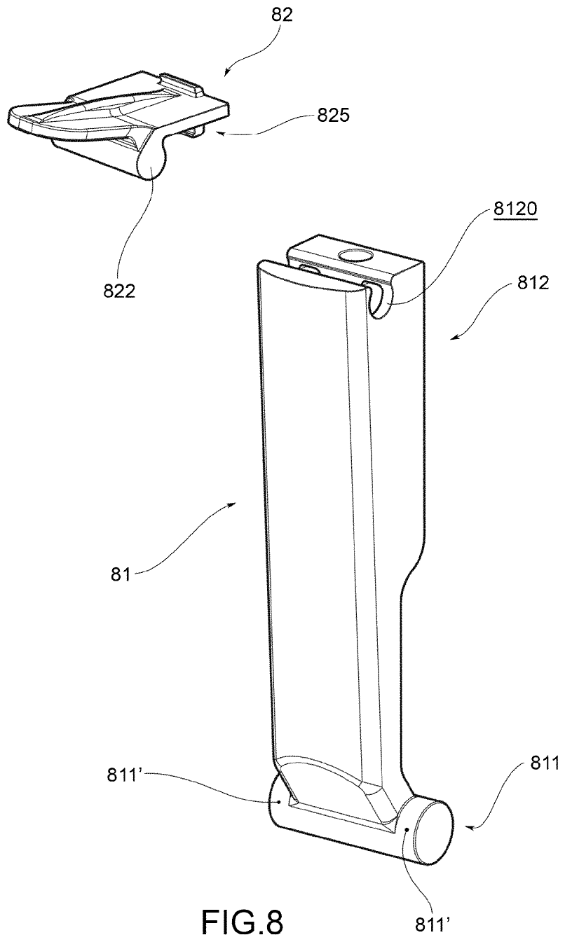

FIG. 8 shows a view with separate parts of some components of a trigger member included in the spray gun object of the present invention;

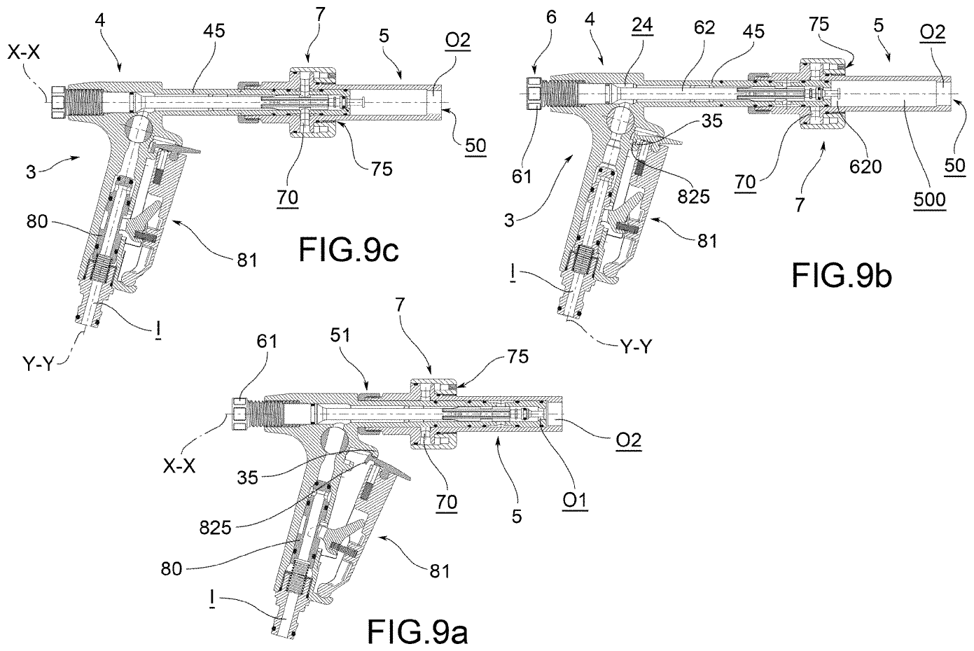

FIGS. 9a, 9b and 9c show some sectional views of a spray gun according to the present invention, in a further preferred embodiment, each corresponding to a respective operating configuration;

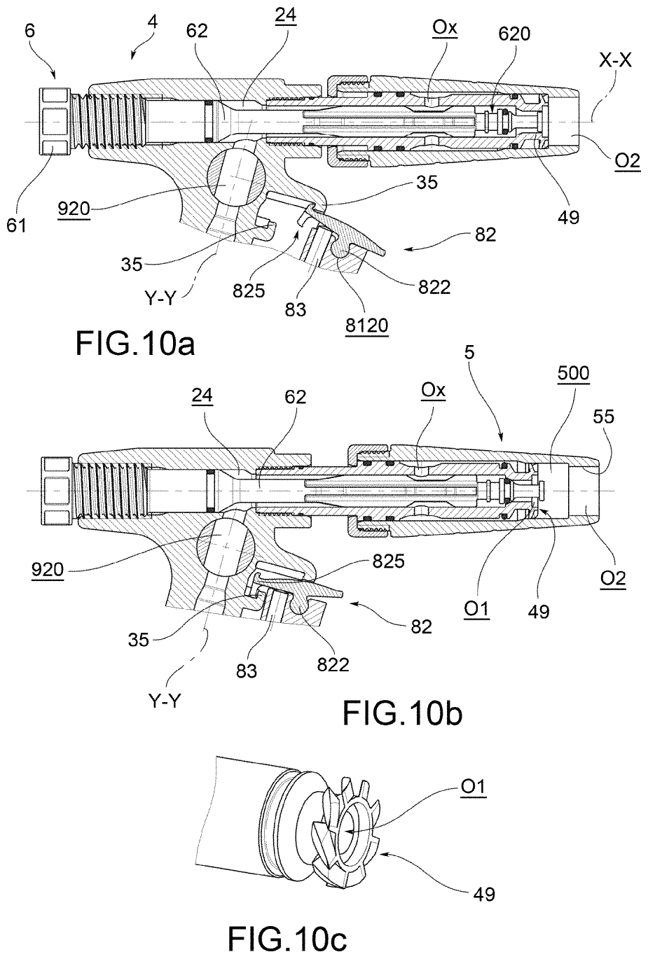

FIGS. 10a, 10b and 10c show two sectional views of a spray gun according to the present invention, in a further preferred embodiment, each corresponding to a respective operating configuration, and a perspective view of a portion of the barrel of said gun.

According to the accompanying figures, reference numeral 1 indicates as a whole a spray gun for the irrigation of plants, flowers and/or vegetables.

Specifically, the spray gun 1 object of the present invention is connectible to a flexible tube which delivers water. By “flexible tube” it is meant a commercial tube which is typically connected to a tap fluidically connected to the domestic and/or industrial water network.

The spray gun 1 comprises a gun body 2 inside of which a duct 20 extends between an inlet mouth I, connectible to the flexible tube that delivers water, and a main outlet mouth O1 through which a predefined quantity of water is sprayed.

According to the present invention, the gun body 2 comprises a handle 3 and a barrel 4.

In a preferred embodiment, handle 3 and barrel 4 are joined together in one piece, in other words the gun body 2 consists of a single component.

In a preferred embodiment, handle 3 and barrel 4 are two distinct components mutually engaged to each other.

In some embodiment variants, the handle 3 consists of the assembly of several parts. In other variants, the handle 3 is a single component.

In some embodiments, the barrel 4 consists of the assembly of several parts. In other variants, the barrel 4 is a single component.

The handle 3 is graspable by a user and extends along a handle axis Y-Y.

In the handle 3, an upper end 30 and a lower end 32 are identified, mutually axially spaced.

The inlet mouth I is formed at the lower end 32. Preferably, the inlet mouth I is at the handle axis Y-Y. Preferably, at the inlet mouth I there is a nozzle engageable by one end of the roll-up tube; preferably, the nozzle and the roll-up tube are mutually joinable together with a male-female releasable coupling.

According to the present invention, the duct 20 has a first section 23 inside the handle 3. Preferably, said first section 23 extends along the handle axis Y-Y.

According to the present invention, the barrel 4 extends along a barrel axis X-X.

The barrel 4 comprises an engagement portion 40 along the barrel axis X-X engaged with the upper end 30 of the handle 3, and a second end 42 in which the main outlet mouth O1 is formed.

The duct 20 has a second section 24 inside the barrel 4 fluidically connected with the first section 23. Preferably, said second section 24 extends along the barrel axis X-X.

Preferably, first section 23 and second section 24 are joined at the intersection of the two respective axes.

Preferably, the barrel 4 extends in length between a first end 41 and a second end 42; the engagement portion 40 is axially located between the first end 41 and the second end 42.

According to the present invention, moreover, the spray gun 1 comprises an adjustment element 5 which extends fitted onto said barrel 4 around and parallel to the barrel axis X-X.

The adjustment element 5 comprises a central cavity in which the barrel 4 is at least partially accommodated and a secondary outlet mouth O2. The secondary outlet mouth O2 corresponds to one end of the cavity 50.

According to the present invention, the adjustment element 5 is axially movable between a retracted position and a forward position. According to a preferred embodiment, the barrel 4 has a front portion 45 on which the adjustment element 5 is fitted axially movable. Preferably, said front portion 45 has a shape substantially complementary to the cavity 50.

In the retracted position, the adjustment element 5 is retracted on the barrel 4. In such a position, the adjustment element 5 has the secondary outlet mouth O2 axially proximal to the main outlet mouth O1, so that the spray of water leaving the main outlet mouth O1 has an unchanged trajectory, i.e. reaches the external environment with the same trajectory with which it is regulated at the exit from the main outlet mouth O1. In other words, in the retracted position the spray is not modified by the presence of the adjustment element 5. In other words, in the retracted position, the spray is delivered by the spray gun 1 exclusively out of the main outlet mouth O1.

Preferably, the adjustment element 5 is retracted axially until it abuts with an abutment formed on the barrel 4; said abutment is placed at the end of the aforementioned section called “front portion 45”.

On the other hand, in the forward position, the adjustment element 5 is axially projected on the barrel 4, having the secondary outlet mouth O2 axially distal to the main outlet mouth O1. In this way, an adjustment chamber 500 is defined inside the central cavity 50 which is filled with water leaving the main outlet mouth O1. In other words, in this configuration the spray gun 1 dispenses water, making it flow through the secondary outlet mouth O2. Preferably, the water comes out of the main outlet mouth O1, stays into and at least partially fills the adjustment chamber 500 and then is dispensed through the secondary outlet mouth O2. In other words, the adjustment chamber 500 is a flow slowing chamber. In other words, thanks to the adjustment chamber 500 the dispensed jet is homogeneous and laminar.

According to a preferred embodiment, the adjustment element 5 is engaged to the barrel by means of a thread. Preferably, in such an embodiment, the axial movement of the adjustment element 5 is obtained by screwing it in clockwise or counter clockwise direction.

According to a preferred embodiment, the adjustment element 5 comprises an annular abutment projection 55 which extends radially towards the barrel axis X-X. Preferably, the annular abutment projection 55 acts as an obstacle to the undisturbed flow of water. In other words, the annular abutment projection 55 has the purpose of forcing the stationing and filling of water in the adjustment chamber and of creating a homogeneous and laminar jet of water leaving the secondary outlet mouth O2.

Preferably, the annular abutment projection 55 is formed on the inner face of the inner cavity 50, in an area proximal to the secondary outlet mouth O2.

Moreover, according to a preferred embodiment, in the forward position the secondary outlet mouth O2 and the primary outlet mouth O1 have a mutual axial distance of between 10 and 150 millimeters. In a preferred embodiment, the secondary outlet mouth O2 and the primary outlet mouth O1 have a mutual axial distance of between 30 and 120 millimeters. In a preferred embodiment, the secondary outlet mouth O2 and the primary outlet mouth O1 have a mutual axial distance of between 50 and 90 millimeters.

According to a preferred embodiment, the secondary outlet mouth O2 is wider than the primary outlet mouth O1. Preferably, also the annular abutment projection 55 defines a larger space than that defined by the primary outlet mouth O1.

Preferably, the primary outlet mouth O1 defines a circular opening with a diameter of between 4 and 12 millimeters.

Preferably, the annular abutment projection 55 defines a circular opening with a diameter of between 10 and 20 millimeters.

Preferably, the secondary outlet mouth O2 defines a circular opening with a diameter of between 12 and 24 millimeters.

According to a preferred embodiment, the adjustment element 5 comprises a support portion 51, placed in an axial position opposite the secondary outlet mouth O1, wherein said support portion 51 engages the barrel 4 in all the axial positions thereof.

According to a preferred embodiment, the barrel 4, in an axial position proximal to the main outlet mouth O1, on its outer side 4, comprises an annular gasket 450 suitable to be engaged by the adjustment element 5, in particular by the inner wall delimiting the central cavity 50.

Preferably, the support portion 51 extends radially to engage the annular gasket 450 acting as a travel stop to the axial movement.

According to a preferred embodiment, in the support portion 51 there is obtained a travel stop groove in which the annular gasket 450 is housed with the adjustment element 5 in the forward position.

According to a preferred embodiment of the invention, the spray gun 1 further comprises a spray calibration member 6.

Preferably, the spray calibration member 6 is adjustable to calibrate the spray of water leaving the main outlet mouth O1 (in particular the shape and intensity of the jet).

The spray calibration member 6 extends parallel to the barrel axis 4 comprising a stem 62 extending into the barrel axis 4 within the second section 24.

Said stem 62 is axially movable. In particular, the position of the stem 62 is axially calibratable, in such a way that particular axial position of the stem 62 corresponds a predefined spray of water leaving the main outlet mouth O1.

The stem 62 comprises a head 620 suitable for being axially arranged in a preferred axial calibration configuration in such a way that, depending on its axial position from the main outlet mouth O1, it corresponds to a type and shape of the water jet.

Preferably, the head 620 is moved axially in the calibration configurations and protrudes from the main outlet mouth O1. In other words, typically the head 620 is on the trajectory of the jet and deviates the direction thereof.

According to some preferred embodiments of the spray gun, an axial calibration configuration corresponds to the occlusion of each passage of the main outlet mouth O1. In such a preferred embodiment, the head 620 engages the edges of the main outlet mouth O1.

According to a preferred embodiment wherein the barrel 4 extends along the barrel axis X-X comprising the first end 41, the calibration member 6 protrudes axially from the first end 41 with a knob 61 operable by the user to calibrate the axial position of the stem 62 and consequently the head 620.

Preferably, the knob 61 is engaged to the stem 62. Preferably, knob 61 and stem 62 are integrally connected.

According to a preferred embodiment, said knob 61 is calibratable in an axial position along the barrel axis XX by screwing (as shown in the accompanying figures), engaging a specific thread. Other preferred embodiments are also provided, in which the knob 61 is calibratable by axial sliding.

According to a preferred embodiment, the water flows in the second section 24 of the duct 20 outside the stem 61.

According to a preferred embodiment, the stem 61 also has one or more longitudinal grooves which guide the water towards the main outlet mouth O1 parallel to the barrel axis X-X.

According to a preferred embodiment, the stem 61 is hollow and the water flows through it to the main outlet mouth O1.

According to such a preferred embodiment, the calibration configurations correspond to different forms of water jet delivered; the calibration configurations correspond to a different intensity of water jet delivered.

Preferably, with the adjustment element 5 in the retracted position, the shape of the jet of water delivered by the spray gun 1 is specifically linked to the way in which the spray calibration member 6 is axially calibrated. On the other hand, with the adjustment element 5 in the forward position, the spray calibration member 6 is axially configured so that the position of the head 620 directs the jet against the inner walls which define the central cavity 50 and therefore the adjustment chamber 500.

In other words, the adjustment element 5 and the spray calibration member 6 have a synergistic effect which facilitates the filling of the adjustment chamber 500.

In addition, according to a preferred embodiment, the spray gun 1 comprises a spray head element 7 suitable for delivering a jet with a large rose-like pattern.

According to a preferred embodiment, the spray head element 7 comprises a perforated portion 75 provided with a plurality of holes through which the jet of water is dispensed. Preferably, said perforated portion 75 has a substantially annular shape around the barrel 4.

In particular, the spray head element 7 is fluidically connectible to the second section 24, for example by means of specific transversal fluidic holes 240.

Preferably, in fact, the spray head element 7 is mounted on the barrel 4 and extends annularly with respect to the barrel axis X-X.

Preferably, the spray head element 7 is positioned proximal to the engagement portion 40.

Preferably, the spray head element 7 is mounted on the front portion 45 of the barrel 4.

In other words, the spray head element 7 is distal from the main outlet mouth O1 being axially positioned in the vicinity of the support portion 51 of the adjustment element 5 in the retracted position.

According to a preferred embodiment, the spray head element 7 defines a water collection chamber 70 (annular) which is filled with water to reach the perforated portion 75

According to a preferred embodiment, the spray head element 7 is axially translatable along the barrel axis X-X between a closed position, in which the fluidic passage is closed, i.e. the specific transversal fluidic communication holes 240 are closed, between the second section 24 and the water collection chamber 70 and an open position, in which the fluidic passage is open, i.e. the specific transversal fluidic communication holes 240 are open, between the second section 24 and the water collection chamber 70 and the water is therefore dispensed through the perforated portion 75.

Preferably, delivery through the spray head element 7 is controlled by axially modulating the calibration member 6 in a configuration in which the head 620 closes the main outlet mouth O1.

According to an embodiment variant, the spray head element 7 is fitted on the adjustment element 5. Therefore, preferably, the spray head element 7 is moved in the axial direction together with the adjustment element 5. According with such an embodiment variant, depending on the axial position of the adjustment element 5 and on the basis of the configuration of the calibration member 6, the water flows out of the secondary outlet mouth O2 after filling the adjustment chamber 500, or it comes out of the spray head element 7.

According to a preferred embodiment, the spray gun 1 further comprises actuation means 8 housed in the handle 3 suitable for being pressed to set or prevent the water flow from flowing.

According to a preferred embodiment, the actuation means 8 are positioned in a suitable operating cavity 300 formed in the handle 3.

Preferably, the operating cavity 300 is delimited laterally (transversely) by handle grips 310, wherein said grips extend in length parallel to the handle axis Y-Y.

Preferably, the actuation means 8 comprise an obturator element 80 movable in the axial direction along the handle axis Y-Y between an obturator position and a spray position.

Preferably, said obturator element 80 is housed inside the first section 23 of the duct 20.

According to a preferred embodiment, the obturator element 80, in the obturator position, prevents the water from flowing in the first section 23 for example by engaging the walls thereof, while in the spray position it leaves a hole open with the walls of the first section 23 through which the water is free to flow.

According to a preferred embodiment, the obturator element 800 is hollow and has a section at its interior in which the water entering from the main inlet mouth I flows.

Preferably, the obturator element 80 comprises a thrust element 805 (preferably a helical spring) which performs a thrust action which keeps it in the obturator position. The actuation of the actuation means 8 by the user is such as to overcome the action of the aforesaid thrust element 805.

According to a preferred embodiment, the actuation means 8 comprise a trigger member 81 operatively connected with the obturator element 80.

Preferably, the trigger member 81 has a shape substantially complementary to the opening defined by the operating cavity 300. Preferably, the trigger member 81 is locked laterally (transversely) by the two handle grips 310.

Preferably, the trigger member 81 is operatively connected to the obturator element 80 by means of a control lever 810 suitable for transmitting the movement action to the obturator element 80 which is therefore linearly moved.

Preferably, said control lever 810 is hinged to the handle 3 rotationally free. Preferably, two housing slots 315 are formed inside the operating cavity 300, suitable for containing specific rotation pins 810′ of the control lever 810.

According to a preferred embodiment, an elastic spring 818 is present and operates between the control lever 810 and the body of the trigger member 81.

Preferably, the trigger member 81 comprises a first end 811 hinged to the handle 3 around which it is movable in rotation between a rest position, in which the obturator element 80 is in an obturator position, and a flattened position in which the obturator element 80 is in a spray position.

According to a preferred embodiment, the handle 3 comprises a special transversal gap in which the first end 811 is inserted and once inserted is rotationally movable.

Preferably, said first end 811 is engaged with the handle 3 being housed in a specially shaped transversal gap.

Preferably, said first end 811 is engaged with the handle 3 being housed in suitable grooves 311 present in the grips 310. In other words, the transversal gap consists of said mutually aligned grooves 311.

Preferably, said first end 811 is inserted in the grooves in the transverse direction Z-Z.

Preferably, the first end 811 has transversal projections 811′ suitable for finding accommodation in said grooves 311.

Preferably, once the transverse insertion has been carried out, until the respective transversal projections are housed in the grooves 311, the trigger member 81 is rotated. The removal of the trigger member 81 therefore provides for a first operation of rotation and then of transversal extraction along the transverse axis Z-Z.

Preferably, the trigger member 81 in a zone proximal to the first end 811 comprises a section of such dimensions that translation in the transverse direction is possible without incurring in geometric abutments.

According to a preferred embodiment, the trigger member 81 comprises a second end 812 on which a hook element 82 is positioned, suitable for being placed in a hooking position in which it engages the handle 3 to maintain the flattened position over time.

In other words, once brought into a flattened position, the trigger member 81 is lockable in such a position by means of the hook element 82.

According to a preferred embodiment, the hook element 82 comprises a fulcrum portion 822 hinged to the second end 812 on which the hook element 82 is free to swing between a locked position and a released position.

In other words, the trigger member 81 comprises a fulcrum housing 8120 in which the fulcrum portion 822 is inserted and once inserted is rotationally movable.

Preferably, the fulcrum portion 822 is insertable in the fulcrum housing 8120 by inserting it in a transverse direction.

According to a preferred embodiment, the trigger member 81 comprises elastic thrust members 83 engaging the hook element 82 suitable for carrying out a thrust action thereon. Preferably, said elastic thrust members 83 are suitable for keeping the hook element 82 raised.

Preferably, the hook element 82 is suitable for engaging the handle 3 so as to keep the second end 812 fixed to the gun body 2.

Preferably, the hook element 82 has a T-shaped element, 825, which engages the handle and suitable locking abutments 35 suitable for configuring the rest positions and in the flattened position.

Preferably, the trigger member 81 is a single component obtained by molding.

Preferably, on the trigger member 81 is mountable to the hook element 82 once the elastic thrust members 83 are housed therein, and once said group of elements is assembled, they are mounted to the handle 3 (in the cavity specifically provided therein), engaging the first end 811 with the handle 3 as described above.

Preferably, the materials of the handle and of the trigger member 81 and of the hook element 82 as well as the geometry of the various components prevent assembly and disassembly other than those described above. Preferably, snap insertions of the various components are geometrically prevented and inhibited.

In addition, the spray gun 1 comprises a control member 9 comprising a valve element 90, inserted in a housing in the gun body 2, wherein said control member 9 is fluidically connected with the duct 20 being specially shaped.

Preferably, the control member 9 is transversal with respect to the duct 20 and is controllable in rotation.

Preferably, the control member 9 is housed in a specially shaped valve housing 29. Preferably, said valve housing 29 is orthogonal to the duct 20.

Preferably, the valve element 90 comprises an auxiliary duct 920 whose alignment with the duct 20 defines the flow rate of water being sprayed.

According to a preferred embodiment, the valve element 90 has a cylindrical shape and is hookable bayonet-wise to the gun body 2.

Preferably, the valve element 90 comprises two mutually transversely spaced gasket elements 98 suitable for preventing any undesired water leaks.

Preferably, the valve element 90 comprises an abutment element 95 which is elastically yielding to allow the operations of insertion of the valve element 90 into the handle. According to a preferred embodiment, the abutment element 95 is collapsible (pressable) in the operations for inserting the valve element 90 into the valve housing 29 and is suitable for regaining to maintain its shape once the abutment element 95 is inserted.

According to a preferred embodiment, the abutment element 95 is suitable for providing the angular travel stops which angularly define the positions of the valve element 90.

Preferably, the abutment element 95 is positioned outside the handle 3, as shown in the accompanying figures.

Moreover, according to a further preferred embodiment, the barrel 4 in the vicinity of the main outlet mouth O1 comprises a turbulence element 49 suitable for making the motion of the water turbulent and in this way more effectively filling the collection chamber 500.

Preferably, thanks to the turbulance element 49, the collection chamber 500 has a smaller axial size.

Preferably, in such an embodiment, the barrel 4 also has auxiliary outlet mouths Ox.

Innovatively, the spray gun according to the present invention achieves the intended object.

Advantageously, the spray gun object of the present invention is suitable for delivering a localized jet of water with low intensity, high flow rate.

Advantageously, the spray gun in its use is suitable for being configurable in a multiplicity of delivery modes. Advantageously, among these modes, the spray gun is also configurable in a configuration in which it is suitable for dispensing a large quantity of water, in a localized manner at low intensity with a homogeneous and laminar jet.

Advantageously, in the feeding of water to plants and/or vegetables, the situation (typical of the solutions of the prior art) of having a localized jet which being high intensity moves the earth underlying the plant is avoided. At the same time, advantageously, in the feeding of water to plants and/or vegetables, the situation (typical of the solutions of the prior art) of having a large rose-like pattern which therefore also wets the plant and its leaves is avoided.

Advantageously, the spray gun is of simple production and assembly.

Advantageously, the spray gun is compact in size. In particular, advantageously, the actuation means are arranged to operate effectively despite having minimal dimensions.

Advantageously, the spray gun is completely dismantlable in each of its parts, in a simple and intuitive manner, making maintenance operations in turn simple and intuitive.

Advantageously, the various components of the spray gun, in particular those relating to the actuation means, are geometrically designed to be mutually engageable by means of specific geometric couplings. Advantageously, specific components are not “snapped” together.

Advantageously, the spray gun is also suitable for solving the problem of the accumulation of scale at its interior, with consequent clogging (also typical of the prior art solutions). Advantageously, in fact, in all the ducts and in all the components bottlenecks such as to have undesired accumulations of scale are avoided. Advantageously, any scale contained in the water is dispensed by the spray gun, avoiding the accumulation thereof.

Advantageously, the calibration means are simple to operate and allow a calibration of the shape of the jet exiting the main outlet mouth.

It is clear that a man skilled in the art may make changes to the invention described above in order to meet incidental needs, all falling within the scope of protection defined in the following claims.

1. A spray gun for irrigating plants, flowers and/or vegetables, the spray gun comprising:
a gun body, a duct extending in said gun body between an inlet mouth, connectible to a flexible tube that delivers water, and a main outlet mouth through which a predefined quantity of water is sprayed, the gun body comprising:
a handle graspable by a user, extending along a handle axis (Y-Y), between an upper end and a lower end, the inlet mouth being located in said lower end, wherein the duct comprises a first section inside the handle; and
a barrel extending along a barrel axis (X-X), between an engagement portion engaged with the upper end of the handle, and a second end, the main outlet mouth being located in said second end, wherein the duct comprises a second section inside the barrel fluidically connected to the first section;
the spray gun further comprising an adjustment element that extends fitted onto said barrel around and parallel to the barrel axis (X-X), the adjustment element comprising a central cavity at least partially accommodating the barrel and a secondary outlet mouth, wherein the adjustment element is axially movable between:
a retracted position, in which the adjustment element is retracted on the barrel, with the secondary outlet mouth axially proximal to the main outlet mouth, whereby water spray from the main outlet mouth has an unchanged trajectory; and
a forward position, in which the adjustment element is advanced axially cantilevered on the barrel, with the secondary outlet mouth axially distal to the main outlet mouth, defining, within the central cavity, an adjustment chamber filled with water exiting the main outlet mouth to flow through the secondary outlet mouth.

2. The spray gun of claim 1, wherein the adjustment element, on an inner face of the central cavity, in an area proximal to the secondary outlet mouth, comprises an annular abutment projection extending toward the barrel axis, suitable for acting as an obstacle to outflow of water.

3. The spray gun of claim 1, wherein in the forward position the secondary outlet mouth and the main outlet mouth have a mutual axial distance between 10 and 150 millimeters.

4. The spray gun of the preceding claim 1, wherein the secondary outlet mouth is wider than the main outlet mouth.

5. The spray gun of claim 1 wherein the adjustment element comprises a support portion, placed in an axial position opposite the secondary outlet mouth, wherein said support portion engages the barrel in all axial positions thereof.

6. The spray gun of claim 5, wherein the barrel, in an axial position proximal to the main outlet mouth, on its outer side comprises an annular gasket, suitable for being engaged by the adjustment element.

7. The spray gun of claim 1, further comprising an adjustable spray calibration member for calibrating the spray of water spray exiting the main outlet mouth, wherein said adjustable spray calibration member extends parallel to the barrel axis and comprises a stem extending into the barrel axis within the second section, the axial position of the stem being calibratable, and wherein the stem comprises a head configured to be axially arranged in a preferred axial calibration configuration in such a way so that, depending on its axial position from the main outlet mouth, it corresponds to a type and shape of water jet.

8. The spray gun of claim 7, wherein the barrel extending along the barrel axis (X-X), comprises a first end axially opposed to the second end, and wherein said adjustable spray calibration member axially protrudes from the first end with a knob operable by the user to calibrate the axial position of the stem and of the head.

9. The spray gun of claim 8, wherein water flows in the second section of the duct, or the stem is hollow and water flows through the stem to the main outlet mouth.

10. The spray gun of claim 1, further comprising a spray head element fluidically connectable to the second section, wherein the spray head element is mounted on the barrel and extends annularly relative to the barrel axis (X-X), positioned proximally to the engagement portion.

11. The spray gun of claim 10, wherein the spray head element is axially movable along the barrel axis (X-X) between a closed position, in which fluid passage is closed to the second section, and an open position in which fluid passage is open to the second section and water is delivered through the spray head element.

12. The spray gun of claim 5, wherein the barrel, in an axial position proximal to the main outlet mouth, on its outer side comprises an annular gasket, suitable for being engaged by an inner wall delimiting the central cavity.
